(19) United States
(12) Patent Application Publication
(10) Pub. No.: US 2026/0304298 A1
(43) Pub. Date: Oct. 1, 2026

(54) CRITICAL UPDATE SIGNALING FOR WIRELESS NETWORKING

(71) Applicant: Cisco Technology, Inc., San Jose, CA (US)

(72) Inventors: Brian D. Hart, Sunnyvale, CA (US); Binita Gupta, San Diego, CA (US); Malcolm Muir Smith, Richardson, TX (US)

(73) Assignee: Cisco Technology, Inc., San Jose, CA (US)

(21) Appl. No.: 19/632,882

(22) Filed: Mar. 30, 2026

Related U.S. Application Data
(60) Provisional application No. 63/780,263, filed on Mar. 29, 2025.

(51) Int. Cl. H04W 48/12; H04W 40/24

(52) U.S. Cl. CPC H04W 48/12; H04W 40/248

(57) ABSTRACT

Critical update signaling for wireless networking may be provided. Critical updates signaling includes implementing, by an access point, a wireless network, including transmitting beacon frames at periodic intervals, wherein the beacon frames include a traffic indication map (TIM) element. In response to an indication of a critical update at the access point a critical update counter value is incremented and a TIM element of a beacon frame transmitted after the indication is encoded to include a critical update indicator field, the critical update indicator field including data indicating the critical update counter value.

### RELATED APPLICATION

Under provisions of 35 U.S.C. § 119(e), Applicant claims the benefit of and priority to U.S. Provisional Application No. 63/780,263, filed Mar. 29, 2025, the disclosure of which is incorporated herein by reference in its entirety.

### TECHNICAL FIELD

The present disclosure relates generally to providing critical update signaling for wireless networking.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for critical updates signaling in accordance with aspects of the present disclosure.

FIG. 2 illustrates a first example beacon frame for critical updates signaling in accordance with aspects of the present disclosure.

FIG. 3 illustrates a second example beacon frame for critical updates signaling in accordance with aspects of the present disclosure.

FIG. 4 illustrates a third example beacon frame for critical updates signaling in accordance with aspects of the present disclosure.

FIG. 5 is a flow diagram illustrating a method for critical updates signaling in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### Overview

Critical update signaling for wireless networking may be provided. Critical updates signaling includes implementing, by an access point, a wireless network, including transmitting beacon frames at periodic intervals, wherein the beacon frames include a traffic indication map (TIM) element. In response to an indication of a critical update at the access point a critical update counter value is incremented and a TIM element of a beacon frame transmitted after the indication is encoded to include a critical update indicator field, the critical update indicator field including data indicating the critical update counter value.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Access Points (APs) and other devices (e.g., stations (STAs)) in an infrastructure or independent basic service set (IBSS)) broadcast beacon frames to advertise the existence of the wireless network and the network’s capabilities and configuration to STAs, also referred to as client devices. STAs trying to connect to the network and STAs already associated to the basic service set (BSS) can receive the beacons.

APs typically broadcast beacons periodically. However, the information in beacons may change intermittently and two or more successive beacons may contain the same or nearly the same information. Operating under the assumption that information commonly does not change between beacons, STAs may not fully parse each beacon to save power. This power saving operation is acceptable until there is a critical update with signaling that the STAs need to receive and identify for correct operation. Examples of critical updates may include, but are not limited to, changes of mode specific parameters for specific features, channel switches, such as those required when detecting radar on a Dynamic Frequency Selection (DFS) channel, changes in operating bandwidth, enabling or disabling of operational modes, and changes in transmit power parameters such as regulatory maximum transmit power limits.

To allow STAs to maintain the power saving operation of partially parsing beacons while ensuring they detect critical updates, various critical update signaling techniques are described herein to indicate when STAs need to parse the information in a respective beacon. To ensure the STAs receive the critical update signaling and associated beacons, in some embodiments, APs can persistently signal critical updates in successive beacons for a duration such that all STAs can detect the existence of a critical update, receive the critical update (by receiving a respective beacon), avoid creating a “gold rush” of probe requests to get the latest information, and still receive a second critical update that occurs partway through the signaling of an earlier critical update (i.e., support overlapped signaling of distinct critical updates).

APs can signal the presence or occurrence of critical updates using a critical update flag in example implementations. In some embodiments, the AP sets a critical update flag in the capability information field to indicate that a critical update signaling is ongoing. This flag may remain asserted throughout the duration of the critical update signaling period.

In some embodiments, the duration for signaling critical updates is based on the listen intervals provided by STAs during association with the AP. The listen interval indicates how many beacon intervals the respective STA will skip while sleeping before waking up to check the beacon, such as to discern any buffered data. The AP may monitor the listen intervals of associated STAs and ensure that critical update signaling persists for at least the largest listen interval among all associated STAs or balances the latency of the elongated signaling versus the Listen Intervals of associated STAs such that the critical update signaling persists longer than a large proportion of the Listen Intervals of its associated STAs and “gold-rush” effect from the remaining STAs is not expected to appreciably degrade the communications of other STAs. In some implementations, the AP may reject association requests from STAs that specify a listen interval that is too large, thereby enabling the AP to limit the duration of critical update signaling while still ensuring all associated STAs can detect the critical updates. The AP 102 may use a specific reason code (e.g., ‘denied listen interval too large’) when rejecting such association requests, allowing the rejected STA 110 to adjust its listen interval to a smaller value and reattempt association.

In certain embodiments, the AP may effectively rate limit critical updates by requiring that critical update signaling (e.g., the critical update flag) be asserted for at least a minimum duration, such as the duration of the largest listen interval, and then de-asserted for at least the same minimum duration before the AP allows itself to signal another critical update. This rate limiting helps ensure that STAs can distinguish between successive critical updates. However, certain critical updates, such as DFS-triggered channel switches, may require immediate signaling and may override rate limiting constraints.

In various embodiments, critical update signaling may be implemented using a counter rather than, or in addition to, a flag. A counter-based approach provides robustness against overlapping critical updates that may occur in quick succession. The counter may increment (for example, modulo 2 to the power of N, where N is the number of bits allocated to the counter) each time a critical update occurs. STAs can monitor the counter value to determine whether a new critical update has occurred since the last beacon they fully processed.

In certain embodiments, the critical update counter is included in a traffic indication map (TIM) element of the beacon frame. The TIM element is typically processed by STAs, including those in sleep states, because it indicates whether buffered traffic is available for the STA. The TIM element has the other advantage that it appears early in the beacon frame so the STA, if it determines there is no important information, can return to doze state earlier. To incorporate the critical update counter, the AP may reserve N association identifiers (AIDs) (e.g., N ranging from 2 to 8) in the partial virtual bitmap of the TIM element for critical update signaling. These reserved AIDs may be located, for example, immediately after or shortly after the AIDs allocated for multicast/broadcast traffic. The reserved N bits form a critical update indicator field that carries the counter value. As used herein, “reserved” is used to signify that the resource is not available for purposes other than described herein, and does not necessarily signify that the resource must be set to 0 on transmit and ignored on receive.

In some embodiments, to provide early detection of a critical update before a STA processes the TIM element, one or more least significant bits (LSBs) of the critical update counter are included in an earlier portion of the beacon frame, such as the capability information field. The capability information field is located early in the beacon frame, allowing STAs to quickly determine whether they should continue processing the beacon to obtain critical update information. In one implementation, a single bit, such as the LSB of the counter, is copied to the capability information field to toggle with each critical update. In another implementation, two LSBs of the counter are copied to the capability information field. With two bits rather than one, the likelihood that a STA will miss a rapid sequence of critical updates is reduced (e.g., when one bit is toggled multiple times in quick succession in a shorter period than an STA’s listen interval so the value appears to stay the same). In another embodiment, an existing field is asserted upon a critical update, either briefly such as until the next Delivery Traffic Indication Message (DTIM) beacon or while the changed information is included in the beacon. The existing field may be de-asserted at other times.

In various alternative embodiments, the critical update counter may be included in different locations within the beacon frame. For example, the counter may be included in an existing parameter change count field, such as a BSS parameter change count (BPCC) field, in a reserved or specially designated triplet of a Country element (using fields such as the Operating Extension Identifier, Operating Class, or Coverage Class fields), in reserved fields of a Quiet element (using fields such as Quiet Count set to a sentinel value with the counter carried in other fields like Quiet Offset), or in a new dedicated element (which may be located near the end of the beacon frame). These alternative locations may allow multi-bit information to be conveyed, in some cases early in the beacon frame, without affecting legacy STA behavior.

Critical update signaling is implemented based on changes in beacon frame length in some embodiments. Because most elements, but not all elements such as the TIM element when formatted in the default manner, in a beacon frame have static sizes or only change size during a critical update, a change in the length of the beacon frame after the TIM element can serve as an indicator of a critical update. An increase in the post-TIM length may indicate that a critical update has occurred and new parameters are being advertised. A decrease in the post-TIM length may indicate that the parameters of a recent critical update are no longer being signaled. To ensure consistent length-based signaling when a critical update does not naturally change the post-TIM length, or when a critical update reduces the post-TIM length, a space filler element can be inserted into the beacon frame. The space filler element can be ignored by STAs and may span a variable number of octets to adjust the beacon frame length as needed to signal critical update status. For example, the space filler element can range from two or three octets to 257 octets. In further embodiments, variable-length elements such as the TIM element may be padded to a fixed length when their length change is non-critical, making the beacon frame length (or post-TIM length) a robust signaling method for critical updates.

In some embodiments, more capable STAs (e.g., ultra-high-reliability (UHR) capable STAs) may report their beacon buffer size to the AP during association or capability exchange. The AP can also determine the beacon buffer size of legacy STAs through testing or prior knowledge. The AP may use the beacon buffer sizes of the different STAs to structure the beacon frame in segments. For example, a first segment may be sized for legacy STAs, including updates understood by legacy STAs, and a second segment (which requires a larger buffer size) may contain critical parameter updates and other information for the more capable and/or more modern STAs. This segmented approach allows critical update information to be included without adversely affecting legacy STA operation.

Through the various embodiments described herein, critical update signaling can be provided in a manner that supports STA power saving, avoids network congestion from simultaneous and near-simultaneous probe requests, accommodates overlapping critical updates, and ensures that all STAs can reliably detect and receive critical network configuration changes.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

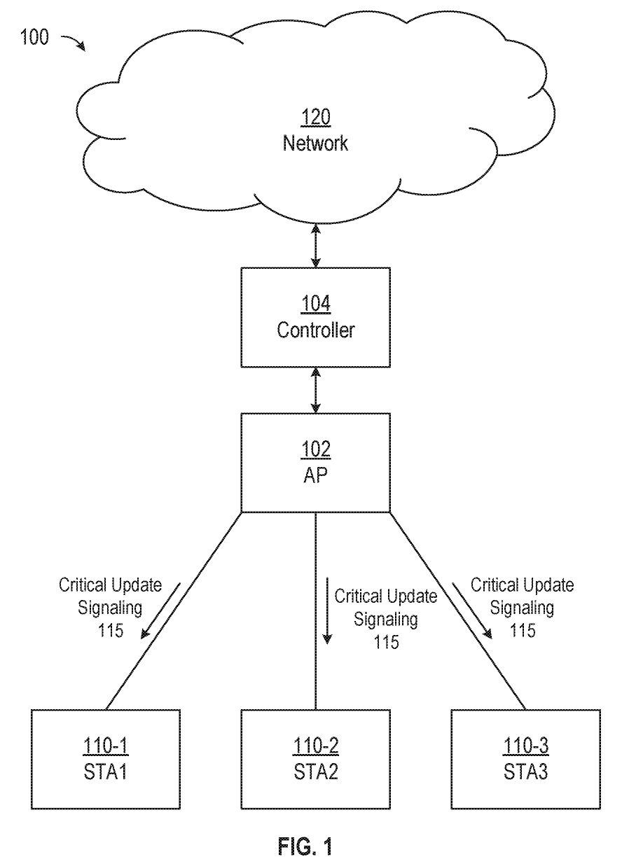

FIG. 1 is a block diagram of an operating environment 100 for critical update signaling. The operating environment 100 includes an AP 102, a controller 104, STAs 110 (illustrated as STA1 110-1, STA2 110-2, and STA3 110-3), and a network 120.

The AP 102 is configured to communicate with and/or enable devices such as the STAs 110 to wirelessly connect to the network 120. The controller 104 is a network controller, such as a Wireless Local Area Network (WLAN) controller, configured to manage and control the AP 102, the STAs 110, and/or other network devices to allow wireless devices to connect to and utilize the network 120. The AP 102 and/or the controller 104 can include router components or connect to an external router for routing traffic and otherwise managing the operation of the WLAN. In certain embodiments, the AP 102 acts as a controller and the controller 104 is not present in the operating environment 100. For example, the AP 102 can include components to act as a WLAN controller.

The STAs 110 are any client device, such as a smartphone, tablet, laptop, a personal computer, an internet-of-things device, or the like. Different STAs 110 may have different capabilities and operational characteristics. To save power, STAs 110 may not fully parse every beacon frame, operating under the assumption that beacon content does not change frequently. During association with the AP 102, each STA 110 can provide its listen interval. The listen interval may be expressed via a multiplier of the beacon period (e.g., eight multiplied by the time between beacons). Different STAs 110 may specify different listen intervals depending on their power saving requirements and operational modes. For example, typical listen interval values may range from one beacon intervals where the STA 110 never enters sleep mode, one beacon interval where the STA 110 skips every other beacon, up to ten beacon intervals or more. STAs 110 with larger listen intervals may spend significant time in sleep states to conserve power, sleeping for seconds at a time for example.

The STAs 110 may also have different beacon processing capabilities. Some STAs 110 may be legacy devices with limited beacon buffer sizes that can only process beacon frames up to a certain maximum length. Other STAs 110 may be more modern or capable devices with larger beacon buffer sizes that can process longer beacon frames containing additional information elements, such as UHR capable STAs. The STAs 110 may report their beacon buffer size to the AP 102 during association or through capability exchange mechanisms.

The network 120 is a set of devices that facilitate communication between senders and destinations, such as by implementing communication protocols. Example networks 120 include local area networks, wide area networks, intranets, or the Internet. In certain embodiments, the network 120 includes one or more systems for managing or otherwise controlling critical update signaling operations.

In operation, the AP 102 implements critical update signaling 115 mechanisms to ensure that all associated STAs 110 can reliably detect and receive critical network configuration changes. When a critical update occurs at the AP 102 (such as a change in mode specific parameters for a specific feature, a channel switch, operating bandwidth change, enabling or disabling of operational modes, or transmit power parameter changes), the AP 102 signals the critical update in a manner that accommodates the diverse listen intervals and capabilities of the associated STAs 110.

In various embodiments, the AP 102 monitors the listen intervals provided by the STAs 110 during association and determines the largest listen interval among all associated STAs 110. The AP 102 then maintains critical update signaling 115 for at least the duration of the largest listen interval to ensure that even STAs 110 that spend most of their time in sleep states will wake up at least once during the signaling period and detect the critical update. In some embodiments, the AP 102 may reject association requests from STAs 110 that specify a listen interval that exceeds a threshold value, thereby limiting the largest listen interval and reducing the duration for which critical update signaling must persist.

To perform critical update signaling 115, the AP 102 may increment a critical update counter in response to detecting or receiving an indication of a critical update. The AP 102 encodes the critical update counter value in a critical update indicator field within the TIM element of beacon frames transmitted after the critical update indication. The TIM element is located relatively early in the beacon frame and is typically processed even by STAs 110 in sleep states because it indicates whether buffered traffic is available for the STA 110. By including the critical update counter in the TIM element, the AP 102 ensures that STAs 110 will encounter the critical update indicator during normal beacon processing.

In some embodiments, the AP 102 may also include one or more least significant bits of the critical update counter in an even earlier portion of the beacon frame, such as the capability information field, to provide an early warning to STAs 110 that a critical update is ongoing. Alternatively or additionally, the AP 102 may set a critical update flag in the capability information field to indicate that a critical update is ongoing and that the STA 110 should continue processing the beacon frame to obtain the full critical update counter value and associated update information.

By implementing these critical update signaling techniques, the operating environment 100 enables reliable delivery of critical network configuration changes to all STAs 110 while supporting power saving operation, avoiding network congestion from simultaneous probe requests, accommodating overlapping critical updates, and ensuring compatibility with legacy STAs.

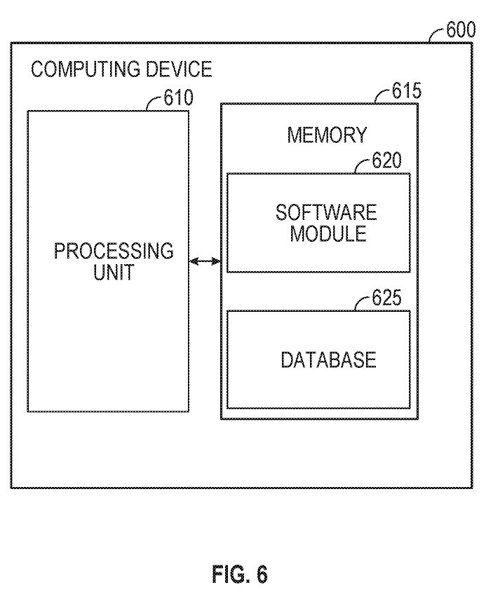

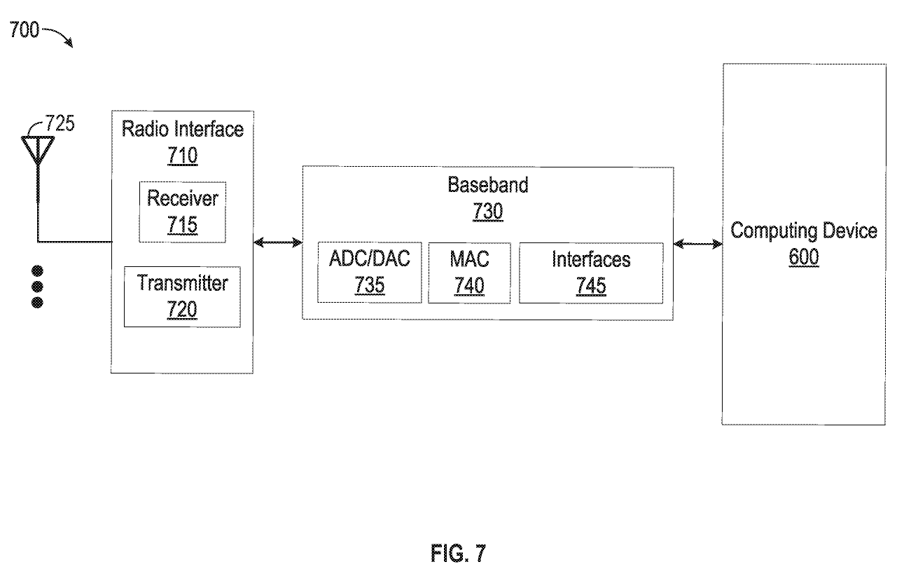

The elements described above of the operating environment 100 (e.g., the AP 102, the controller 104, the STAs 110, the systems of the network 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

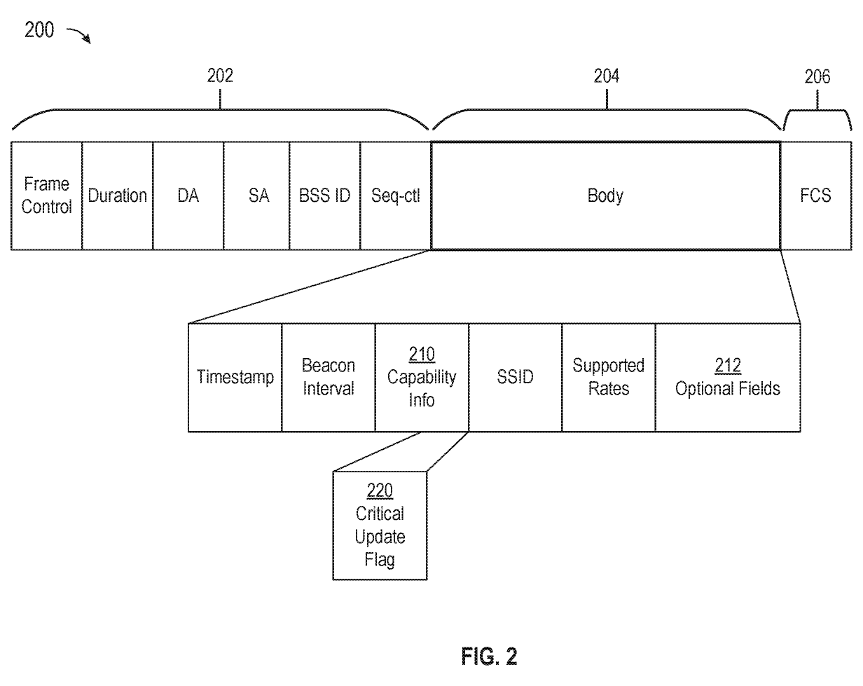

FIG. 2 illustrates a first example beacon frame 200 for critical updates signaling. The beacon frame includes a header 202, a body 204, and a trailer 206. The header 202 is a Media Access Control (MAC) header in example implementations. The trailer 206 comprises a frame check sequence in example implementations.

The body 204 includes, among other fields, a capability information field 210 and optional fields 212. The capability information field 210 includes a critical update flag 220 in certain embodiments. In example implementations, the critical update flag 220 is located early in the beacon frame 200 to allow STAs 110 to quickly determine whether a critical update is ongoing before processing the remainder of the beacon. When the AP 102 detects or receives an indication of a critical update, the AP 102 sets the critical update flag 220 to a value (e.g., one) to indicate that the critical update is ongoing. The AP 102 maintains the critical update flag 220 in the asserted state for at least the duration of the longest listen interval among all associated STAs 110, ensuring that all STAs 110 wake up and detect the existence of the critical update during the signaling period.

In some embodiments, the AP 102 may implement rate limiting by asserting the critical update flag 220 for at least the longest listen interval, then de-asserting the critical update flag 220 for at least the longest listen interval before allowing itself to assert the critical update flag 220 again for a subsequent critical update. This rate limiting approach helps ensure that STAs 110 can distinguish between successive critical updates by providing sufficient time for each STA 110 to observe both the asserted and de-asserted states of the critical update flag 220. However, certain critical updates, such as channel switches required when detecting radar on a DFS channel, may be obligatory and may need to be signaled immediately, potentially overriding the rate limiting constraints.

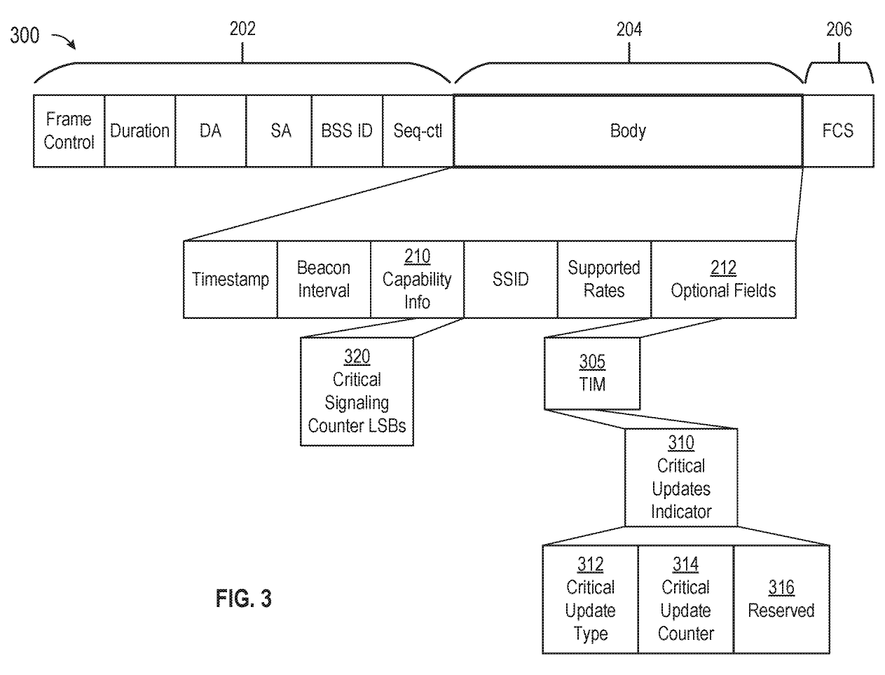

While the critical update flag 220 provides early signaling, it has certain limitations when used alone. If the critical update flag 220 is set to signal a first critical update (e.g., set to one), then set to indicate no critical updates (e.g., set to zero), and then set back to again to signal a second critical update, a STA 110 that misses the sequence where the critical update flag 220 was set to indicate no critical updates may not be able to identify the existence of the second critical update. Additionally, the flag approach cannot reliably report a second change during the signaling period of an earlier change. For these reasons, counter-based approaches (described below with respect to FIG. 3) may be used in addition to or as an alternative to the critical update flag 220.

FIG. 3 illustrates a second example beacon frame 300 for critical updates signaling also having the header 202, the body 204, and the trailer 206. The optional fields 212 include a TIM 305, and the TIM 305 includes a critical updates indicator field 310 (also referred to as a critical update indicator field). The capability information field 210 includes a critical signaling counter LSBs field 320 in various embodiments.

The critical updates indicator field 310 comprises a critical update type field 312, a critical update counter field 314, and a reserved field 316 in example implementations. The critical update type field 312 may be three bits, the critical update counter field 314 four bits, and the reserved field one bit in some embodiments. The critical update type field 312 can be set to indicate a type of the critical update. The critical update counter field 314 is set as described herein to increment every time there is a critical update.

The TIM 305 is located relatively early in the beacon frame 300 and is typically processed even by STAs 110 in sleep states because the TIM 305 indicates whether buffered traffic is available for the STA 110. To incorporate the critical updates indicator field 310, the AP 102 reserves N AIDs (for example, N ranging from two to eight) in the partial virtual bitmap of the TIM 305 for critical update signaling. The TIM 305 is structured with a partial bitmap where each client device is normally given one bit position to indicate whether traffic is buffered for that device. The reserved N bits (reserved AIDs) are used to carry the critical updates indicator field 310. In some implementations, these reserved AIDs may be located immediately after or shortly after the AIDs allocated for multicast/broadcast traffic (e.g., after the first sixteen AIDs for an AP in a multiple BSS Identifier set). In certain standardized implementations, bits 56 to 63 of the partial virtual bitmap have been designated for this purpose.

The critical updates indicator field 310 increments modulo 2 to the power of N (where N is the number of bits allocated to the counter) each time a critical update occurs. For example, if N equals 3 (three bits), the counter increments modulo 8 (cycling through values 0 through 7). If N equals 4 (four bits), the counter increments modulo 16 (cycling through values 0 through 15). When an STA 110 wakes up and processes a beacon frame 300, the STA 110 can compare the critical update counter field 314 value to the counter value from the last beacon the STA 110 fully processed to determine whether one or more critical updates have occurred. The counter-based approach is robust against overlapping critical updates that may occur in quick succession, because each critical update increments the counter value, allowing STAs 110 to detect successive updates even if they occur during the signaling period of an earlier update.

To provide even earlier detection of a critical update before an STA 110 processes the TIM 305, one or more least significant bits of the critical updates indicator field 310 may be included in the critical signaling counter LSBs field 320 in the capability information field 210. Since the capability information field 210 is located early in the beacon frame 300, the STA 110 can quickly determine whether to continue processing the beacon to obtain the full critical updates indicator field 310 value and associated update information from the TIM 305 and subsequent portions of the beacon.

In one implementation, a single LSB of the critical updates indicator field 310 may be copied or moved to the critical signaling counter LSBs field 320, where it toggles with each critical update. However, this single-bit approach creates some risk that STAs 110 may only monitor this value and miss rapid successive critical updates. For example, if the counter changes twice quickly (e.g., zero to one, then one to zero), the intermediate value is not signaled for a sufficient time to ensure STAs 110 identify the change. Thus, if the STAs 110 monitor only the single LSB without checking the full counter in the TIM 305, the STAs 110 might miss the updates. This single-bit approach may be acceptable when used in conjunction with rate limiting (as described with respect to FIG. 2).

In further implementations, two (or more) least significant bits of the critical updates indicator field 310 are copied or moved to the critical signaling counter LSBs field 320. Using two LSBs reduces the likelihood of STAs 110 missing rapid successive updates because of the larger number of values that can be indicated with multiple bits. In some embodiments, the critical update counter field 314 may be limited to just two bits in length when used with rate limiting, and both bits can be included in the critical signaling counter LSBs field 320. In some implementations, the existing Critical Update field is used to signal or hint that it is worthwhile for STAs to continue receiving the beacon until the TIM element.

In various alternative embodiments not illustrated in FIG. 3, the critical updates indicator field 310 or the critical update counter field 314 alone may be included in different locations within the beacon frame. In one implementation, the critical updates indicator field 310 reuses an existing BPCC field in the beacon frame. In another implementation, the critical updates indicator field 310 is inserted into a triplet of a Country element by assigning a particular value to an Operating Extension Identifier field and/or Operating Class field for this purpose, and carrying the counter in a portion of a Coverage Class field (and/or Operating Class field if not needed for identification). In yet another alternative, a Quiet element may be populated with a sentinel value (such as Quiet Count equal to 255) so that legacy STAs interpret the quiet period as being far in the future, and one or more of the remaining fields of the Quiet element (such as Quiet Period, Quiet Duration, or Quiet Offset) may be used to carry the critical updates indicator field 310. The Quiet Period may be maximized and/or the Quiet Duration may be minimized to special or well-known values for additional compatibility. In still another implementation, the critical updates indicator field 310 may be included in a new dedicated element, likely located near the end of the beacon frame. These alternative locations for the critical updates indicator field 310 can be used more generally to send multi-bit information early in a beacon frame without affecting legacy STA behavior.

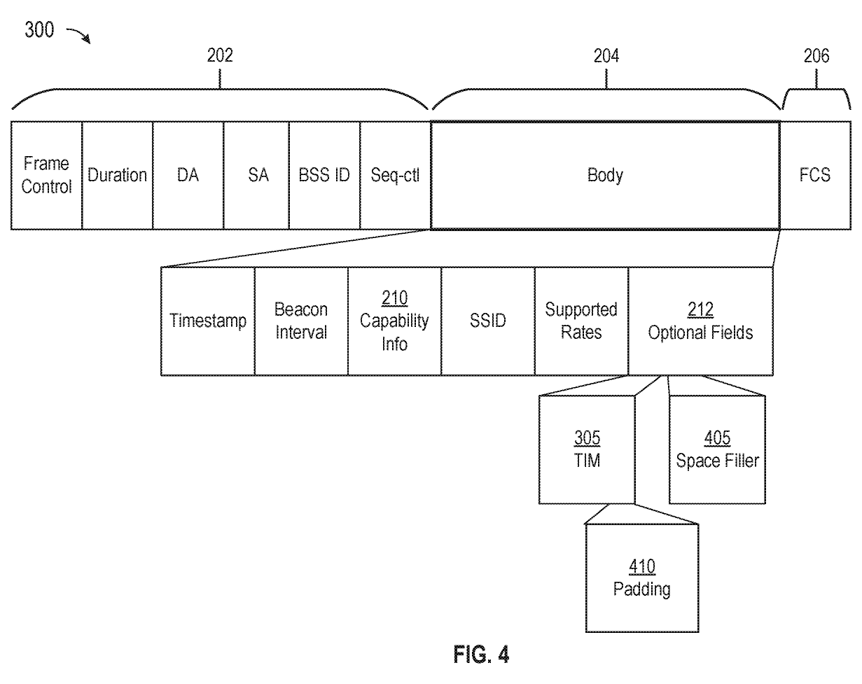

FIG. 4 illustrates a third example beacon frame 400 for critical updates signaling also having the header 202, the body 204, and the trailer 206. The beacon frame 400 includes a space filler field 405, such as a space filler element, in the optional fields 212. The space filler field 405 is positioned after the TIM 305 in example implementations. The beacon frame 400 also includes a padding field 410 in the TIM 305 in various embodiments.

The AP 102 can use changes in the length of the beacon frame 400 as a method of signaling critical updates. In example implementations, the AP 102 specifically uses the length of the beacon frame 400 after the TIM 305, referred to as the “post-TIM length,” to signal the presence of critical updates. Most elements in the beacon frame 400 have static sizes, and if an element changes size, it typically indicates a critical update. However, the TIM 305 is an exception because it is a variable-length element that changes size based on non-critical factors (such as which clients have buffered traffic). By monitoring the post-TIM length, this variability can be isolated.

In this length-based signaling approach, if the post-TIM length of newer beacons has increased compared to previous beacons, then an STA 110 can interpret this as indicating that a critical update has occurred. Conversely, if the post-TIM length of newer beacons has decreased compared to previous beacons, then the STA 110 can interpret this as indicating that the parameters of a recent critical update are no longer being signaled.

To address situations where the presence of critical updates do not naturally result in consistent length changes, the AP 102 can insert the space filler field 405 into the beacon frame 400. The space filler field 405 is ignored by STAs 110 and can span a variable number of octets. In example implementations, the space filler field 405 may range from 2 or 3 octets to 257 octets, structured with an Element ID field (1 octet), a Length field (1 octet, which can signal 0-255 additional octets), and potentially an Element ID Extension field (1 octet).

The AP 102 utilizes the space filler field 405 to adjust the post-TIM length as needed to maintain consistent length-based signaling. If a critical update occurs but the post-TIM length does not naturally change (e.g., because the critical update changes a value in an element but not the element’s size), the AP 102 may include the space filler field 405 with a minimal number of octets (such as 2 or 3) to increase the post-TIM length and signal the critical update. If a critical update occurs but the post-TIM length naturally reduces (e.g., if the AP 102 changes from composite mode to standard power-only or low power indoor-only mode, requiring fewer transmit power envelope elements, or if the AP 102 reduces operating bandwidth from 320 MHz to 40 MHz, requiring fewer power spectral density fields in the related transmit power envelope elements), the AP 102 may include the space filler field 405 with enough octets to compensate for the reduction and ensure that the post-TIM length is increasing. If overlapping back-to-back critical updates occur, the space filler field 405 can continue to increase in size at each critical update to maintain the length-based signaling pattern.

In some embodiments, the AP 102 may add the padding field 410 to the TIM 305 (and/or other variable-length elements in the beacon frame 400) to pad these elements to a fixed length when their length change is non-critical. By padding variable-length elements to a fixed length, the overall beacon frame length becomes a feasible and potentially earlier signaling method for critical updates because changes in beacon frame length can be attributed primarily to critical updates rather than to incidental variations in variable-length elements.

The elements of the beacon frames 200, 300, 400 described with respect to FIGS. 2-4 can be used in various combinations to enable concurrent utilization of any of the described features. For example, a beacon frame may include both the critical update flag 220 in the capability information field 210 (as shown in FIG. 2) and the critical updates indicator field 310 in the TIM 305 (as shown in FIG. 3), providing both an early flag-based indication and a more robust counter-based indication of critical updates. Similarly, a beacon frame may include the critical updates indicator field 310 in the TIM 305, the critical signaling counter LSBs field 320 in the capability information field 210, and the space filler field 405 for length-based signaling, providing multiple complementary mechanisms for critical update detection. The AP 102 (or the standard definers) may select which combination of features to implement based on factors such as the capabilities of associated STAs 110, the frequency of critical updates, power consumption considerations, beacon frame size constraints, and compatibility requirements with legacy devices.

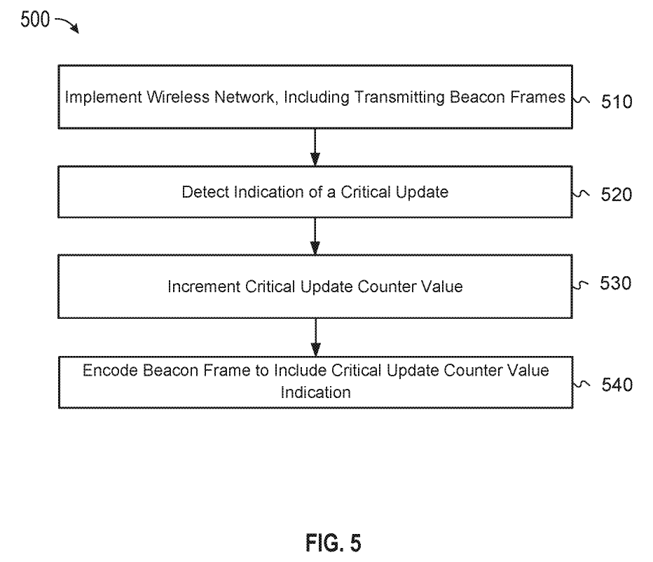

FIG. 5 illustrates a method 500 for critical update signaling in a wireless network. The method 500 may be performed by the AP 102, the controller 104, or a combination thereof. In certain embodiments, the method 500 is performed by one or more processors of the AP 102 executing instructions stored in one or more memories.

At stage 510, the AP 102 implements a wireless network, including transmitting (e.g., enqueuing for transmitting) beacon frames at periodic intervals, wherein the beacon frames include a TIM element.

At stage 520, the AP 102 detects or receives an indication of a critical update. The indication of a critical update may be generated internally by the AP 102 or received from the controller 104 or another network device. Examples of critical updates include, but are not limited to, changes in mode specific parameters for specific features (e.g., changes in transmit power parameters), channel switches, changes in operating bandwidth, and enabling or disabling of operational modes. In some embodiments, the critical update may be an obligatory change that must be implemented immediately, such as a DFS-triggered channel switch. In other embodiments, the critical update may be a discretionary change that can be delayed or scheduled.

At stage 530, in response to the indication of the critical update, the AP 102 increments a critical update counter value. In various embodiments, the critical update counter value is incremented modulo 2 to the power of N, where N is a number of bits allocated to the critical update counter value.

At stage 540, the AP 102 encodes a TIM element of a beacon frame transmitted after the indication to include a critical update indicator field, the critical update indicator field including data indicating the critical update counter value. For example, the critical update counter field 314 of the critical updates indicator field 310 can include the data indicating the critical update counter value. In some embodiments, the critical update indicator field is included in a partial virtual bitmap field of the TIM element. In various embodiments, the critical update indicator field is included in a reserved location of the TIM element. In certain embodiments, the beacon frame is transmitted a predetermined period of time before the critical update is effected.

In some embodiments, the method 500 further includes incrementing a parameter change count value, and the beacon frame transmitted after the indication is encoded to include the parameter change count value in a reserved field of an element of the beacon frame.

In various embodiments, the method 500 further includes including one or more least significant bits of the critical update counter value in a capability information field of the beacon frame. For example, one or more bits of the critical update counter value are included in the critical signaling counter LSBs field 320.

In certain embodiments, the method 500 further includes setting a critical update flag to a value to indicate the critical update is ongoing, wherein the critical update flag is in a capability information field of the beacon frame. For example, the critical update flag 220 is set to indicate the critical update is ongoing. The critical update flag may be used in conjunction with the critical update counter value to provide both flag-based and counter-based signaling mechanisms.

In various embodiments, the method 500 may further include utilizing beacon frame length changes as an additional signaling mechanism. The AP 102 may insert a space filler element into the beacon frame to adjust the post-TIM length to indicate the occurrence or conclusion of a critical update. The AP 102 may also add padding to the TIM element and/or other variable-length elements to maintain fixed lengths when their length change is non-critical, making overall beacon frame length an even earlier indicator of critical updates.

The method 500 may be implemented by the AP 102 executing instructions stored in one or more non-transitory computer readable storage media. The instructions, when executed by one or more processors of the AP 102, cause the processors to perform the operations of stages 510, 520, 530, and 540, along with any of the additional operations described above.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing critical updates signaling. Computing device 600, for example, may provide an operating environment for the AP 102, the controller 104, the STAs 110, the systems of the network 120, and the like. The AP 102, the controller 104, the STAs 110, the systems of the network 120, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 600 on the single integrated circuit (chip).

FIG. 7 illustrates an implementation of a communications device 700 that may implement one or more of the AP 102, the controller 104, the STAs 110, the systems of the network 120, etc. In various implementations, the communications device 700 may comprise a logic circuit. The logic circuit may include physical circuits to perform operations described for one or more of the AP 102, the controller 104, the STAs 110, the systems of the network 120, etc., for example. As shown in FIG. 7, the communications device 700 may include one or more of, but is not limited to, a radio interface 710, baseband circuitry 730, and/or the computing device 600.

The communications device 700 may implement some or all of the structures and/or operations for the AP 102, the controller 104, the STAs 110, the systems of the network 120, etc., storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or Physical (PHY) layer processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method, comprising:
implementing, by an access point, a wireless network, including transmitting beacon frames at periodic intervals, wherein the beacon frames include a traffic indication map (TIM) element; and
in response to an indication of a critical update at the access point:
incrementing a critical update counter value; and
encoding a TIM element of a beacon frame transmitted after the indication to include a critical update indicator field, the critical update indicator field including data indicating the critical update counter value.

2. The method of claim 1, wherein the critical update indicator field is included in a partial virtual bitmap field of the TIM element.

3. The method of claim 1, wherein the critical update indicator field is included in a reserved location of the TIM element.

4. The method of claim 1, wherein the critical update counter value is incremented modulo 2 to the power of N, where N is a number of bits allocated to the critical update counter value.

5. The method of claim 1, wherein the beacon frame is transmitted a predetermined period of time before the critical update is effected.

6. The method of claim 1, further comprising:
incrementing a parameter change count value; and
wherein the beacon frame transmitted after the indication is encoded to include the parameter change count value in a reserved field of an element of the beacon frame.

7. The method of claim 1, further comprising:
including one or more least significant bits of critical update counter value in a capability information field of the beacon frame.

8. The method of claim 1, further comprising:
setting a critical update flag to a value to indicate the critical update is ongoing, wherein the critical update flag is in a capability information field of the beacon frame.

9. An access point, comprising:
one or more memories; and
one or more processors communicatively coupled to the one or more memories, wherein the one or more processors are configured to, individually or collectively, perform operations comprising:
implementing, by the access point, a wireless network, including transmitting beacon frames at periodic intervals, wherein the beacon frames include a traffic indication map (TIM) element; and
in response to an indication of a critical update at the access point:
incrementing a critical update counter value; and
encoding a TIM element of a beacon frame transmitted after the indication to include a critical update indicator field, the critical update indicator field including data indicating the critical update counter value.

10. The access point of claim 9, wherein the critical update indicator field is included in a partial virtual bitmap field of the TIM element.

11. The access point of claim 9, wherein the critical update indicator field is included in a reserved location of the TIM element.

12. The access point of claim 9, wherein the critical update counter value is incremented modulo 2 to the power of N, where N is a number of bits allocated to the critical update counter value.

13. The access point of claim 9, wherein the beacon frame is transmitted a predetermined period of time before the critical update is effected.

14. The access point of claim 9, the operations further comprising:
incrementing a parameter change count value; and
wherein the beacon frame transmitted after the indication is encoded to include the parameter change count value in a reserved field of an element of the beacon frame.

15. One or more non-transitory computer readable storage media encoded with instructions that, when executed by a processor of an access point, cause the processor to perform operations comprising:
implementing, by the access point, a wireless network, including transmitting beacon frames at periodic intervals, wherein the beacon frames include a traffic indication map (TIM) element; and
in response to an indication of a critical update at the access point:
incrementing a critical update counter value; and
encoding a TIM element of a beacon frame transmitted after the indication to include a critical update indicator field, the critical update indicator field including data indicating the critical update counter value.

16. The one or more non-transitory computer readable storage media of claim 15, wherein the critical update indicator field is included in a partial virtual bitmap field of the TIM element.

17. The one or more non-transitory computer readable storage media of claim 15, wherein the critical update indicator field is included in a reserved location of the TIM element.

18. The one or more non-transitory computer readable storage media of claim 15, wherein the critical update counter value is incremented modulo 2 to the power of N, where N is a number of bits allocated to the critical update counter value.

19. The one or more non-transitory computer readable storage media of claim 15, wherein the beacon frame is transmitted a predetermined period of time before the critical update is effected.

20. The one or more non-transitory computer readable storage media of claim 15, the operations further comprising
incrementing a parameter change count value; and
wherein the beacon frame transmitted after the indication is encoded to include the parameter change count value in a reserved field of an element of the beacon frame.
